(19) United States
(12) Patent Application Publication
(10) Pub. No.: US 2024/0101212 A1
(43) Pub. Date: Mar. 28, 2024

(54) FIXING STRUCTURE

(71) Applicant: SUZUKI MOTOR CORPORATION, Hamamatsu-shi (KR)

(72) Inventor: Hikaru KIZU, Hamamatsu-shi (JP)

(73) Assignee: SUZUKI MOTOR CORPORATION, Hamamatsu-shi (KR)

(21) Appl. No.: 18/365,827

(22) Filed: Aug. 4, 2023

(30) Foreign Application Priority Data
Sep. 22, 2022 (JP) 2022-150948

(51) Int. Cl. B62J 17/04

(52) U.S. Cl. CPC B62J 17/04

(57) ABSTRACT

A fixing structure includes a first attachment portion provided in the first member, a second attachment portion provided in the second member, and a clip configured to fix the first attachment portion and the second attachment portion to each other. The first attachment portion is formed with an attachment hole into which a tip end side of the clip is inserted. The second attachment portion is formed with an attachment and detachment hole through which the clip is configured to pass, and a holding hole through which a base end side of the clip is configured not to pass. The attachment and detachment hole and the holding hole are formed to be continuous with each other. The clip is configured to be moved from the attachment and detachment hole to the holding hole. The second member is formed with a design portion covering the second attachment portion.

### CROSS-REFERENCE TO RELATED APPLICATIONS

This application is based on and claims priority under 35 USC 119 from Japanese Patent Application No. 2022-150948 filed on Sep. 22, 2022, the entire content of which is incorporated herein by reference.

### TECHNICAL FIELD

The present disclosure relates to a fixing structure.

### BACKGROUND ART

In the related art, a structure for fixing a cover using a clip is known (for example, see JPH11-198883A). In the fixing structure described in JPH11-198883A, the cover is overlapped on a down tube from the outside, mounting holes of the down tube and the cover are aligned, and the clip is inserted into the mounting holes of the down tube and the cover from the outside. The clip is a push rivet including a grommet and a pin, and the pin is partially inserted into an insertion hole of the grommet. When the pin is pushed into the insertion hole of the grommet, a tip end of the grommet opens radially outward, and the cover is fixed to the down tube via the clip.

However, in the fixing structure described in JPH11-198883A, since the clip is inserted from the outside of the cover, the clip is exposed to the outside after the cover is fixed to the down tube. In order to improve the appearance, the clip needs to be hidden by another cover or the like, which complicates the structure. Such a problem may occur not only in a case where the cover and the down tube are fixed to each other but also in a case where other members are fixed to each other.

### SUMMARY OF INVENTION

Aspect of non-limiting embodiments of the present disclosure relates to provide a fixing structure capable of fixing members to each other while preventing exposure of a clip. Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a fixing structure for fixing a first member and a second member to each other, the fixing structure including:
a first attachment portion provided in the first member;
a second attachment portion provided in the second member; and
a clip configured to fix the first attachment portion and the second attachment portion to each other,
in which the first attachment portion is formed with an attachment hole into which a tip end side of the clip is inserted,
the second attachment portion is formed with an attachment and detachment hole through which the clip is configured to pass, and a holding hole through which a base end side of the clip is configured not to pass, the attachment and detachment hole and the holding hole being formed to be continuous with each other,
the clip is configured to be moved from the attachment and detachment hole to the holding hole, and
the second member is formed with a design portion covering the second attachment portion.

### BRIEF DESCRIPTION OF DRAWINGS

Exemplary embodiment(s) of the present invention will be described in detail based on the following figures, wherein:

FIG. 1 is a right side view of a front portion of a straddle-type vehicle according to an exemplary embodiment of the present invention;

FIG. 2 is a view showing a fixing operation of a side cover and a meter cover according to a modification;

FIG. 3 is a perspective view of a fixing structure of covers of FIG. 1;

FIG. 4 is a plan view of the fixing structure of the covers of FIG. 3 as viewed from a fixing direction;

FIG. 5 is a bottom view of a tab-shaped bracket according to the exemplary embodiment of the present invention as viewed from a side opposite to the fixing direction;

FIG. 6 is a sectional view of the tab-shaped bracket of FIG. 5 taken along a line VI-VI;

FIG. 7A is a view showing a temporary fastening operation of a clip to the meter cover according to the exemplary embodiment of the present invention;

FIG. 7B is a view showing the temporary fastening operation of the clip to the meter cover according to the exemplary embodiment of the present invention;

FIG. 7C is a view showing the temporary fastening operation of the clip to the meter cover according to the exemplary embodiment of the present invention; and

FIG. 8 is a view showing a fixing operation of a side cover and a meter cover according to the exemplary embodiment of the present invention.

### DESCRIPTION OF EMBODIMENTS

A fixing structure according to an aspect of the present disclosure is a structure for fixing a first member and a second member. The first member is provided with a first attachment portion. The second member is provided with a second attachment portion. The first attachment portion and the second attachment portion are fixed by a clip. The first attachment portion is formed with an attachment hole into which a tip end side of the clip is inserted. The second attachment portion is formed with an attachment and detachment hole through which the clip is passable, and a holding hole through which a base end side of the clip is impassable. The attachment and detachment hole and the holding hole are formed to be continuous with each other. The clip is configured to be moved from the attachment and detachment hole to the holding hole. The second attachment portion is covered with a design portion of the second member. The second attachment portion is formed on a back side of the design portion of the second member. The base end side of the clip is inserted into the attachment and detachment hole from the back side even in a case where the clip cannot be inserted, from a design portion side, into the attachment and detachment hole of the second attachment portion. The clip is moved from the attachment and detachment hole to the holding hole in a state where the base end side of the clip protrudes through the attachment and detachment hole. The base end side of the clip is held in the holding hole of the second attachment portion of the second member, the tip end side of the clip is inserted into the attachment hole of the first attachment portion of the first member, and the first member and the second member are fixed by the clip. In addition, the clip is hidden by the design portion of the second member, and appearance is improved.

### Embodiment

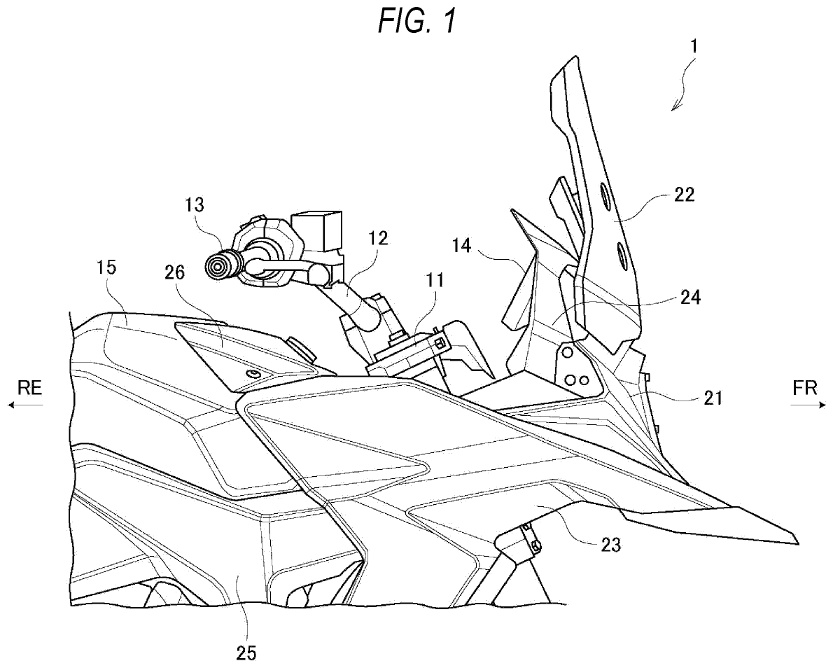

Hereinafter, a straddle-type vehicle according to the present embodiment will be described with reference to the accompanying drawings. FIG. 1 is a right side view of a rear half of a straddle-type vehicle according to an embodiment. In the following drawings, an arrow FR indicates a vehicle front side, an arrow RE indicates a vehicle rear side, an arrow L indicates a vehicle left side, and an arrow R indicates a vehicle right side.

As shown in FIG. 1, a front fork 11 is supported on a front portion of a straddle-type vehicle 1, and a handle 13 is provided above the front fork 11 via a handle bar 12. A meter cover 24 is disposed in front of the front fork 11, and a periphery of the meter 14 is covered with the meter cover 24. A front cover 21 is disposed in a front side of the meter cover 24, and a periphery of a headlamp that is not shown is covered with the front cover 21. A screen 22 for windbreak is attached to an upper portion of the front cover 21, and a front space of the handle 13 is covered with the screen 22 from the front side.

A pair of side covers 23 are disposed in both sides of the front fork 11, and a periphery of a head pipe that is not shown is covered from the side by each of the side covers 23. A pair of tank rail covers 25 are disposed in rear lower sides of the pair of side covers 23, and a tank rail, which is not shown, on a lower side of a fuel tank 15 is covered from the side by each of the tank rail covers 25. A center cover 26 is disposed in rear upper sides of the pair of side covers 23, and the front of the fuel tank 15 is covered with the center cover 26. A streamline shape that reduces air resistance from traveling wind is formed in a vehicle front portion by the various covers.

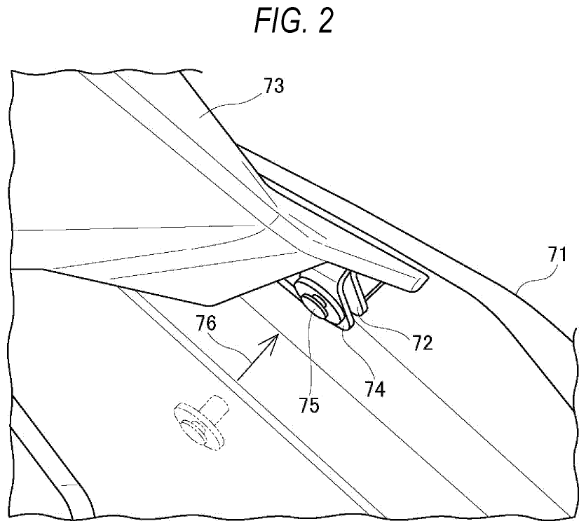

As shown in a comparative example of FIG. 2, a clip 75 such as a push rivet is used to fix the covers to each other. Here, a side cover 71 and a meter cover 73 are fixed by the clip 75. An attachment portion 74 of the meter cover 73 is aligned with an attachment portion 72 of the side cover 71 from the inside, and the clip 75 is inserted, from the inside, into attachment holes of the attachment portions 72 and 74. Since the meter cover 73 is formed to avoid an insertion path 76 of the clip 75 with respect to the attachment portions 72 and 74, the clip 75 inserted into the attachment portions 72 and 74 cannot be covered with the meter cover 73.

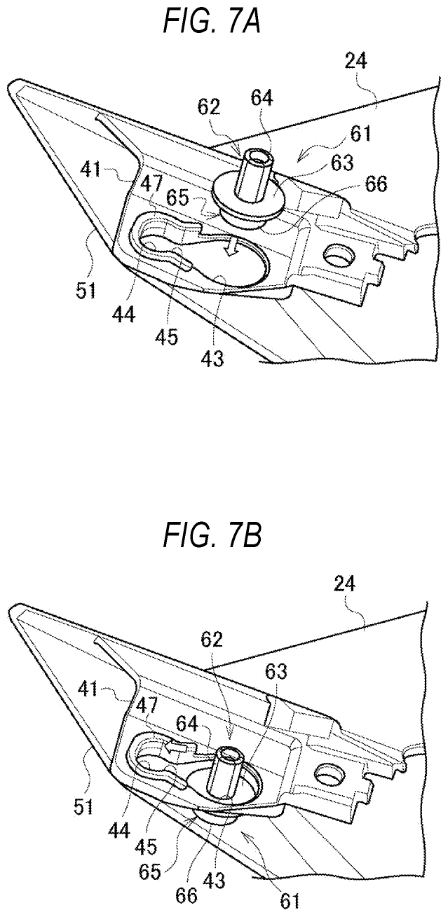

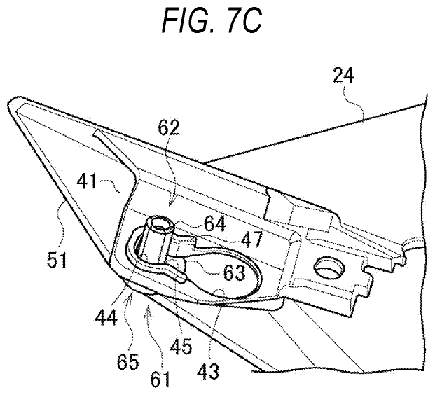

Therefore, the clip 75 of the attachment portions 72 and 74 of the side cover 71 and the meter cover 73 are exposed, and appearance is deteriorated. Although the clip 75 can be covered by adding a cover, the structure of the cover becomes complicated as the number of assembling steps increases. In the present embodiment, a design portion 51 is formed in the meter cover 24 to face an attachment portion of the meter cover 24, and a clip 61 is formed to be insertable into the attachment portion from a direction in which the clip 61 does not interfere with the design portion 51 (see FIGS. 7A, 7B, and 7C). Accordingly, the side cover 23 and the meter cover 24 are fixed by the clip 61 while preventing exposure of the clip 61.

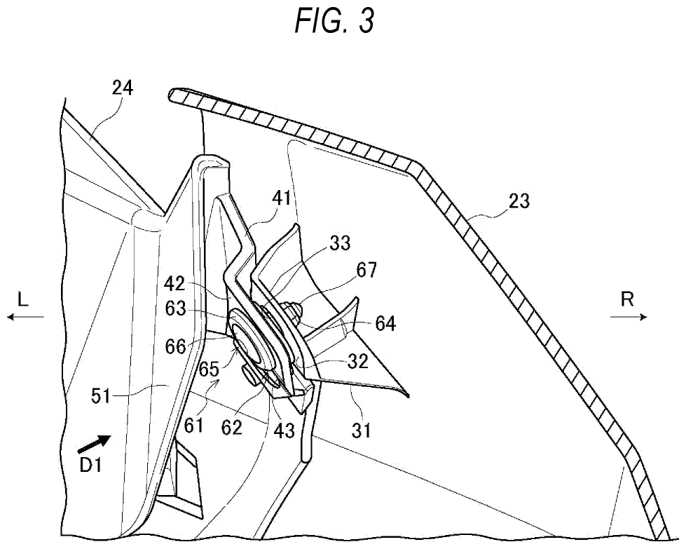

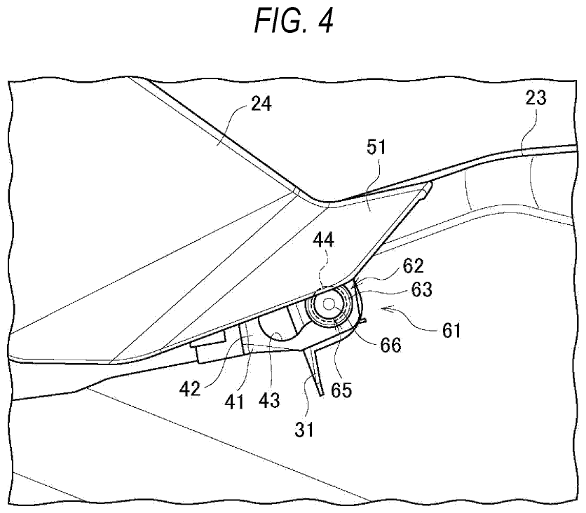

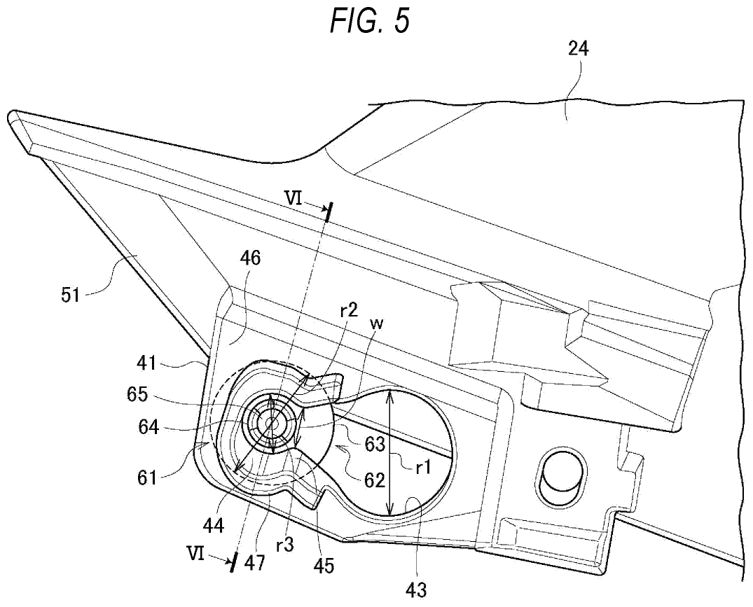

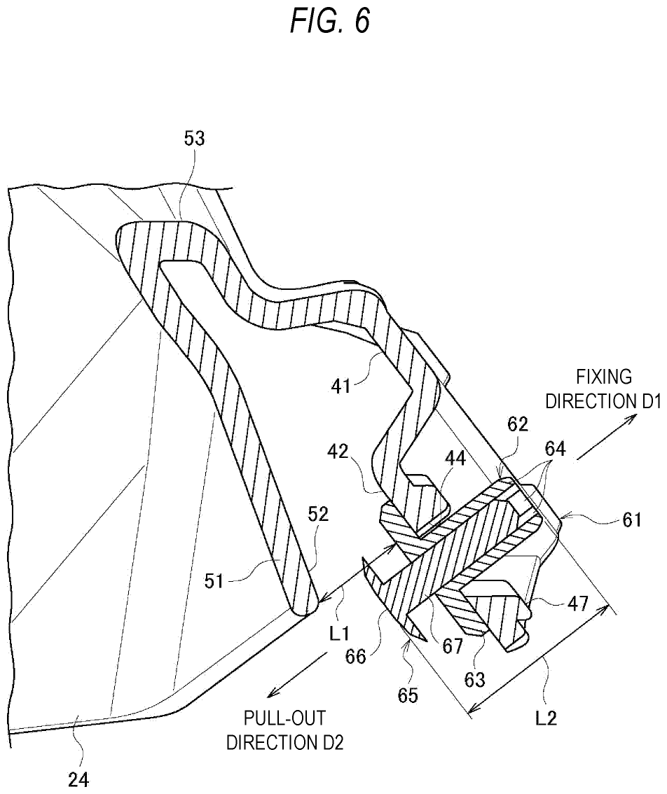

A detailed configuration of a fixing structure of the covers will be described with reference to FIGS. 3 to 6. FIG. 3 is a perspective view of the fixing structure of the covers of FIG. 1. FIG. 4 is a plan view of the fixing structure of the covers of FIG. 3 as viewed from a fixing direction. FIG. 5 is a bottom view of a tab-shaped bracket according to the present embodiment as viewed from a side opposite to the fixing direction. FIG. 6 is a sectional view of the tab-shaped bracket of FIG. 5 taken along a line VI-VI.

As shown in FIGS. 3 and 4, in the fixing structure according to the present embodiment, the side cover (first member) 23 and the meter cover (second member) 24 are fixed to each other via the clip 61. A pedestal-shaped bracket (first attachment portion) 31 is provided in an inner surface of the side cover 23. An attachment hole 33 is formed in an attachment surface 32 at a tip end of the pedestal-shaped bracket 31. A tab-shaped bracket (second attachment portion) 41 extends from both left and right ends of the meter cover 24. The tab-shaped bracket 41 faces the pedestal-shaped bracket 31. An attachment surface 42 of the tab-shaped bracket 41 is recessed to avoid the attachment surface 32 of the pedestal-shaped bracket 31. An attachment and detachment hole 43 and a holding hole 44 are formed in the attachment surface 42 of the tab-shaped bracket 41.

The clip 61 is inserted into the attachment hole 33 of the pedestal-shaped bracket 31 and the holding hole 44 of the tab-shaped bracket 41, and the pedestal-shaped bracket 31 and the tab-shaped bracket 41 are fixed to each other by the clip 61. The clip 61 includes a grommet 62 serving as a base and a pin 65 inserted into the grommet 62. A base end side of the grommet 62 is a flange 63. A tip end side of the grommet 62 is a plurality of leg pieces 64 arranged in a cylindrical shape. A base end side of the pin 65 is a disk-shaped head portion 66. A tip end side of the pin 65 is a shaft portion 67 passing inside the plurality of leg pieces 64. In a case where the pin 65 is inserted into the grommet 62, the clip 61 is finally fastened.

More specifically, in a temporary fastening state of the clip 61, the flange 63 of the grommet 62 is supported by the tab-shaped bracket 41, and the shaft portion 67 of the pin 65 is partially inserted into the grommet 62. The plurality of leg pieces 64 of the grommet 62 form a cylinder whose diameter decreases toward the tip end. An inner diameter of the attachment hole 33 of the pedestal-shaped bracket 31 is larger than an outer diameter of the cylinder formed by the plurality of leg pieces 64. In a case where the shaft portion 67 of the pin 65 is pushed inward with respect to the grommet 62 from the temporary fastening state, the plurality of leg pieces 64 of the grommet 62 are opened outward in a radial direction, the plurality of leg pieces 64 are pressed against an opening edge of the attachment hole 33, and the tab-shaped bracket 41 and the pedestal-shaped bracket 31 are fixed to each other.

The meter cover 24 is provided with the design portion 51 that covers the tab-shaped bracket 41 from an inner side in a vehicle width direction. The design portion 51 faces the tab-shaped bracket 41, and the tab-shaped bracket 41 is partially covered with the design portion 51 as viewed from a fixing direction D1 of the clip 61. As viewed from the fixing direction D1, the tab-shaped bracket 41 appears to protrude from the design portion 51. As viewed from a position higher than the side cover 23 or the like, the tab-shaped bracket 41 is covered and hidden by the design portion 51. By reducing the exposure of a fixing portion of the clip 61, the design of the straddle-type vehicle 1 is improved.

As shown in FIG. 5, the attachment and detachment hole 43 and the holding hole 44 are formed in the tab-shaped bracket 41. The attachment and detachment hole 43 and the holding hole 44 are formed to be continuous. The clip 61 is configured to be moved from the attachment and detachment hole 43 to the holding hole 44. In the illustrated example, the clip 61 is temporarily fastened to the holding hole 44 of the tab-shaped bracket 41. An inner diameter r1 of the attachment and detachment hole 43 is larger than an outer diameter r2 of the flange 63 on the base end side of the grommet 62. The clip 61 has a size that allows the clip 61 to pass through the attachment and detachment hole 43. The flange 63 of the grommet 62 is configured to be inserted into the attachment and detachment hole 43 from a back side of the meter cover 24 that does not interfere with the design portion 51.

An inner diameter r3 of the holding hole 44 is smaller than the outer diameter r2 of the flange 63 on the base end side of the grommet 62. An inner diameter r3 of the holding hole 44 is larger than an outer diameter of the cylindrical portion formed by the plurality of leg pieces 64 on the tip end side of the grommet 62. The flange 63 of the grommet 62 has a size in which the flange 63 cannot pass through the holding hole 44. The clip 61 is held by the holding hole 44. A width w of a communicating portion 45 between the attachment and detachment hole 43 and the holding hole 44 is smaller than the inner diameter r3 of the holding hole 44. The communicating portion 45 between the attachment and detachment hole 43 and the holding hole 44 is constricted, and the clip 61 is less likely to return from the holding hole 44 to the attachment and detachment hole 43. Thus, the side cover 23 and the meter cover 24 are easily fixed by the clip 61.

A diameter of the cylinder formed by the plurality of leg pieces 64 of the grommet 62 is reduced by the communicating portion 45, and the clip 61 is configured to be moved from the attachment and detachment hole 43 to the holding hole 44. In a case where the clip 61 is moved from the attachment and detachment hole 43 to the holding hole 44, the diameter of the cylinder formed by the plurality of leg pieces 64 decreases. In a case where the clip 61 reaches the holding hole 44, the diameter of the cylinder formed by the plurality of leg pieces 64 increases. In addition, since the width w of the communicating portion 45 between the attachment and detachment hole 43 and the holding hole 44 is smaller than the outer diameter of the enlarged cylinder of the plurality of leg pieces 64, the clip 61 is less likely to return from the holding hole 44 to the attachment and detachment hole 43. Thus, the side cover 23 and the meter cover 24 are easily fixed by the clip 61.

An opening edge of the holding hole 44 protrudes from a back surface 46 of the tab-shaped bracket 41. The opening edge of the holding hole 44 is formed thicker than the opening edge of the attachment and detachment hole 43. An axial deviation of the clip 61 temporarily fastened to the holding hole 44 is reduced by a thick portion 47. Thus, the clip 61 can be stabilized in a case where the side cover 23 and the meter cover 24 are fixed. The thick portion 47 extends from the holding hole 44 to the communicating portion 45. The clip 61 is guided by the thick portion 47 in a case where the clip 61 is moved between the attachment and detachment hole 43 and the holding hole 44. Since a posture of the clip 61 is adjusted by the thick portion 47, the clip 61 is easily moved between the attachment and detachment hole 43 and the holding hole 44 while maintaining a stable posture.

As shown in FIG. 6, a facing interval between the design portion 51 of the meter cover 24 and the tab-shaped bracket 41 is smaller than an entire length L2, in the fixing direction D1, of the clip 61 in the temporary fastening state. More specifically, a facing interval L1 between a back surface 52 of the design portion 51 and the attachment surface 42 of the tab-shaped bracket 41 is smaller than an entire length L2, in the fixing direction D1, of the clip 61 in the temporary fastening state. In a state where the clip 61 is temporarily fastened in the holding hole 44, a movement of the clip 61 in a pull-out direction D2 is restricted by the design portion 51. Even in a case where the clip 61 is about to come off the holding hole 44, the clip 61 is received by the design portion 51. The clip 61 is less likely to fall off from the holding hole 44, and the side cover 23 and the meter cover 24 are easily fixed by the clip 61.

The meter cover 24 is made of a flexible resin material. The design portion 51 of the meter cover 24 and the tab-shaped bracket 41 form a folded shape, in a cross-sectional view. The design portion 51 is configured to approach the tab-shaped bracket 41 with the folded portion 53 as a fulcrum. The design portion 51 faces the clip 61 of the tab-shaped bracket 41. The design portion 51 is configured to be pressed to push the clip 61 (pin 65). The clip 61 is pushed in while the design portion 51 is elastically deformed, and the side cover 23 and the meter cover 24 can be fixed while the clip 61 is hidden on the back side of the design portion 51.

As shown in FIG. 4, after the side cover 23 and the meter cover 24 are fixed (finally fastened), the clip 61 is configured to be moved from the holding hole 44 to the attachment and detachment hole 43. The clip 61 is crimped with the attachment hole 33 (see FIG. 3) of the pedestal-shaped bracket 31 of the side cover 23. The clip 61 is moved from the holding hole 44 to the attachment and detachment hole 43 by sliding the side cover 23 with respect to the meter cover 24. In a case where the clip 61 is removed from the attachment and detachment hole 43, the side cover 23 is removed from the meter cover 24 together with the clip 61. Therefore, the side cover 23 can be removed from the meter cover 24 without removing the clip 61.

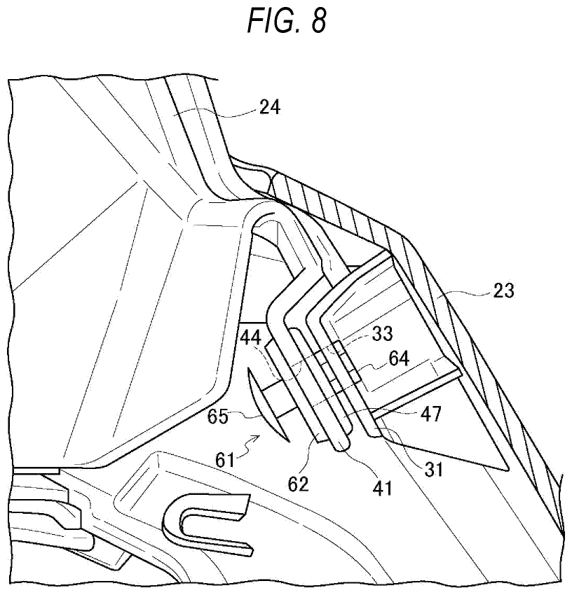

A fixing operation of the side cover and the meter cover will be described with reference to FIGS. 7A to 8. FIGS. 7A to 7C are views showing a temporary fastening operation of a clip to the meter cover according to the present embodiment. FIG. 8 is a view showing the fixing operation of the side cover and the meter cover according to the present embodiment.

As shown in FIG. 7A, the shaft portion 67 (see FIG. 6) of the pin 65 of the clip 61 is partially inserted into the grommet 62, and the head portion 66 of the pin 65 is separated from the flange 63 of the grommet 62. The clip 61 is inserted into the attachment and detachment hole 43 from the side that the clip 61 does not interfere with the design portion 51. That is, the clip 61 is inserted into the attachment and detachment hole 43 from the back side of the tab-shaped bracket 41. The flange 63 side, which is a base end side, of the clip 61 is inserted into the attachment and detachment hole 43, and the flange 63 of the clip 61 protrudes through the attachment and detachment hole 43 to the design portion 51 side. Since the inner diameter of the attachment and detachment hole 43 is larger than the outer diameter of the flange 63, the flange 63 side of the clip 61 is smoothly inserted into the attachment and detachment hole 43 from a direction opposite to the fixing direction D1 (see FIG. 6).

As shown in FIG. 7B, in a case where the flange 63 side of the clip 61 is inserted into the attachment and detachment hole 43, the clip 61 is moved from the attachment and detachment hole 43 to the holding hole 44. Although the communicating portion 45 between the attachment and detachment hole 43 and the holding hole 44 is constricted, the plurality of leg pieces 64 arranged in the cylindrical shape on a tip end side of the clip 61 are deformed inward to allow the clip 61 to pass through the plurality of leg pieces 64. The thick portion 47 is formed in an opening edge of the communicating portion 45. The movement of the clip 61 is guided by the thick portion 47. Since the plurality of leg pieces 64 of the clip 61 are brought into sliding contact with the thick portion 47, the axial deviation of the clip 61 is reduced. Thus, the clip 61 is smoothly moved from the attachment and detachment hole 43 to the holding hole 44.

As shown in FIG. 7C, in a case where the clip 61 reaches the holding hole 44 beyond the communicating portion 45, the clip 61 is held in the holding hole 44 and is temporarily fastened to the tab-shaped bracket 41. At this time, since the inward deformation of the plurality of leg pieces 64 of the clip 61 is released, the outer diameter of the cylinder formed by the plurality of leg pieces 64 becomes larger than the width of the communicating portion 45. Thus, the clip 61 is less likely to return from the holding hole 44 to the attachment and detachment hole 43. In addition, since the tab-shaped bracket 41 and the design portion 51 face each other with the flange 63 of the clip 61 interposed between the tab-shaped bracket 41 and the design portion 51, the clip 61 is prevented from falling off from the holding hole 44 by the design portion 51.

As shown in FIG. 8, in a case where the clip 61 is temporarily fastened to the tab-shaped bracket 41, the side cover 23 is disposed on the meter cover 24. The pedestal-shaped bracket 31 is aligned with the tab-shaped bracket 41, and the tip end of the clip 61 enters the attachment hole 33 of the pedestal-shaped bracket 31. Since the clip 61 is supported by the thick portion 47 of the holding hole 44, the clip 61 is inserted into the attachment hole 33 in a state where the axial deviation of the clip 61 is reduced. Then, in a case where the pin 65 of the clip 61 is pushed via the design portion 51, the plurality of leg pieces 64 of the grommet 62 are brought into pressure contact with the attachment hole 33, and the meter cover 24 and the side cover 23 are fixed via the clip 61.

As described above, according to the fixing structure of the present embodiment, the tab-shaped bracket 41 is formed on the back side of the design portion 51 of the meter cover 24, and the base end side of the clip 61 is inserted into the attachment and detachment hole 43 from the back side even in a case where the clip 61 cannot be inserted into the attachment and detachment hole 43 of the tab-shaped bracket 41 from the design portion 51 side. The clip 61 is moved from the attachment and detachment hole 43 to the holding hole 44 in a state where the base end side of the clip 61 protrudes through the attachment and detachment hole 43. The base end side of the clip 61 is held in the holding hole 44 of the tab-shaped bracket 41 of the meter cover 24, the tip end side of the clip 61 is inserted into the attachment hole 33 of the pedestal-shaped bracket 31 of the side cover 23, and the side cover 23 and the meter cover 24 are fixed by the clip 61. In addition, the clip 61 is hidden by the design portion 51, and appearance is improved.

In the present embodiment, a configuration in which the first member is the side cover and the second member is the meter cover has been described, but the first member and the second member may be members that can be fixed by the clip.

Although the fixing structure of the covers of the straddle-type vehicle has been described in the present embodiment, the fixing structure may be adopted in another vehicle or another device.

In the present embodiment, a configuration in which the clip is a push rivet has been described, but a structure of the clip is not particularly limited as long as the clip can fix the first member and the second member.

In the present embodiment, the pedestal-shaped bracket is provided as the first attachment portion in the side cover, but the shape or the like of the first attachment portion is not particularly limited as long as the attachment hole is formed in the first attachment portion.

In the present embodiment, the tab-shaped bracket is provided as the second attachment portion in the meter cover, but the shape or the like of the second attachment portion is not particularly limited as long as the attachment and detachment hole and the holding hole are continuously formed in the second attachment portion.

In the present embodiment, the opening edge of the holding hole is formed thicker than the opening edge of the attachment and detachment hole, but the thickness of the opening edge of the holding hole is not particularly limited. For example, if the tab-shaped bracket has a sufficient thickness, the clip can be stably held by the holding hole even in a case where the opening edge of the holding hole and the opening edge of the attachment and detachment hole are formed to have the same thickness.

As described above, according to a first aspect, there is provided a fixing structure for fixing a first member (side cover 23) and a second member (meter cover 24) to each other, the fixing structure including: a first attachment portion (pedestal-shaped bracket 31) provided in the first member; a second attachment portion (tab-shaped bracket 41) provided in the second member; and a clip (61) configured to fix the first attachment portion and the second attachment portion to each other. The first attachment portion is formed with an attachment hole (33) into which a tip end side of the clip is inserted. The second attachment portion is formed with an attachment and detachment hole (43) through which the clip is configured to pass, and a holding hole (44) through which a base end side of the clip is configured not to pass. The attachment and detachment hole and the holding hole are formed to be continuous with each other. The clip is configured to be moved from the attachment and detachment hole to the holding hole. The second member is formed with a design portion (51) covering the second attachment portion. According to this configuration, the second attachment portion is formed on a back side of the design portion of the second member, and the base end side of the clip is inserted into the attachment and detachment hole from the back side even in a case where the clip cannot be inserted into the attachment and detachment hole of the second attachment portion from a design portion side. The clip is moved from the attachment and detachment hole to the holding hole in a state where the base end side of the clip protrudes through the attachment and detachment hole. The base end side of the clip is held in the holding hole of the second attachment portion of the second member, the tip end side of the clip is inserted into the attachment hole of the first attachment portion of the first member, and the first member and the second member are fixed by the clip. In addition, the clip is hidden by the design portion of the second member, and appearance is improved.

According to a second aspect, in the first aspect, a facing interval between the second attachment portion and the design portion is smaller than an entire length, in a fixing direction, of the clip in a temporary fastening state. According to this configuration, in a state where the clip is temporarily fastened to the holding hole, a movement of the clip in a pull-out direction is restricted by the design portion. The clip is less likely to fall off from the holding hole, and the first member and the second member are easily fixed by the clip.

According to a third aspect, in the first aspect and the second aspect, the design portion is configured to be pressed to push the clip. According to this configuration, the clip is pushed in while the design portion is elastically deformed, and the first member and the second member can be fixed while the clip is hidden on the back side of the design portion.

According to a fourth aspect, in any one of the first aspect to the third aspect, a width of a communicating portion (45) between the attachment and detachment hole and the holding hole is smaller than an inner diameter of the holding hole. According to this configuration, the communicating portion between the attachment and detachment hole and the holding hole is constricted, the clip is less likely to return from the holding hole to the attachment and detachment hole, and the first member and the second member are easily fixed by the clip.

According to a fifth aspect, in the fourth aspect, the width of the communicating portion is formed to be smaller than an outer diameter of the tip end side of the clip, and the tip end side of the clip is reduced in diameter by the communicating portion in a case where the clip is moved from the attachment and detachment hole to the holding hole, such that the clip is configured to move from the attachment and detachment hole to the holding hole. According to this configuration, in a case where the clip moves from the attachment and detachment hole to the holding hole, the tip end side of the clip decreases in diameter, and in a case where the clip reaches the holding hole, the tip end side of the clip increases in diameter. The clip is less likely to return from the holding hole to the attachment and detachment hole, and the first member and the second member are easily fixed by the clip.

According to a sixth aspect, in any one of the first aspect to the fifth aspect, an opening edge of the holding hole is formed thicker than an opening edge of the attachment and detachment hole. According to this configuration, an axial deviation of the clip temporarily fastened to the holding hole is reduced by the thick portion, and the clip can be stabilized in a case where the first member and the second member are fixed.

According to a seventh aspect, in any one of the first aspect to the sixth aspect, the first member is a cover of a vehicle. According to this configuration, the cover of the vehicle can be easily attached, and the appearance of the vehicle can be improved.

According to an eighth aspect, in any one of the first aspect to the seventh aspect, the clip is configured to be moved from the holding hole to the attachment and detachment hole after the first attachment portion and the second attachment portion are fixed to each other. According to this configuration, the first member is slid with respect to the second member, and the first member is detached from the second member together with the clip. As a result, the first member can be removed from the second member without removing the clip.

Although the present embodiment has been described, other embodiments may be used in which the above embodiment and modification are combined entirely or partially.

In addition, the technology of the present invention is not limited to the above embodiment, and may be variously changed, replaced, or modified without departing from the gist of the technical concept. Further, as long as the technical concept can be realized in another way by the progress of the technique or another derivative technique, the present invention may be implemented using the method. Therefore, the claims cover all embodiments that may fall within the scope of the technical concept.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing structure for fixing a first member and a second member to each other, the fixing structure comprising:
a first attachment portion provided in the first member;
a second attachment portion provided in the second member; and
a clip configured to fix the first attachment portion and the second attachment portion to each other,
wherein the first attachment portion is formed with an attachment hole into which a tip end side of the clip is inserted,
the second attachment portion is formed with an attachment and detachment hole through which the clip is configured to pass, and a holding hole through which a base end side of the clip is configured not to pass, the attachment and detachment hole and the holding hole being formed to be continuous with each other,
the clip is configured to be moved from the attachment and detachment hole to the holding hole, and
the second member is formed with a design portion covering the second attachment portion.

2. The fixing structure according to claim 1,
wherein a facing distance between the second attachment portion and the design portion is smaller than an entire length, in a fixing direction, of the clip in a temporary fastening state.

3. The fixing structure according to claim 1,
wherein the design portion is configured to be pressed to push the clip.

4. The fixing structure according to claim 1,
wherein a width of a communicating portion between the attachment and detachment hole and the holding hole is smaller than an inner diameter of the holding hole.

5. The fixing structure according to claim 4,
wherein the width of the communicating portion is formed to be smaller than an outer diameter of the tip end side of the clip, and the tip end side of the clip is reduced in diameter by the communicating portion in a case where the clip is moved from the attachment and detachment hole to the holding hole, such that the clip is configured to be moved from the attachment and detachment hole to the holding hole.

6. The fixing structure according to claim 1,
wherein an opening edge of the holding hole is formed thicker than an opening edge of the attachment and detachment hole.

7. The fixing structure according to claim 1,
wherein the first member is a cover of a vehicle.

8. The fixing structure according to claim 1,
wherein the clip is configured to be moved from the holding hole to the attachment and detachment hole after the first attachment portion and the second attachment portion are fixed to each other.
